(19) United States
(12) Patent Application Publication
(10) Pub. No.: US 2009/0327907 A1
(43) Pub. Date: Dec. 31, 2009

(54) INTEGRATING CHARACTER-BASED PROFILES WITHIN A SOCIAL NETWORK

(75) Inventors: Julio Estrada, Medina, WA (US); Gretchen G. Eichinger, Seattle, WA (US); Michael G. Lucerno, Bellevue, WA (US); Charles O. Heineman, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/165,565

(22) Filed: Jun. 30, 2008

(51) Int. Cl. G06F 3/048; G06F 15/16

(52) U.S. Cl. 715/739; 709/217

(57) ABSTRACT

Profiles that are character-based and which reflect various brand assets are supported in a social networking service by an arrangement that enables members to interact with the branded character-based profiles in the same way as profiles of any real members of the social network. Branded characters may thus be befriended and their profiles shared with other users, rated, and discussed.

### CROSS REFERENCE TO RELATED APPLICATIONS

This application is related to co-pending U.S. patent application Ser. No. ______ (Attorney Docket No. 320252.01), U.S. patent application Ser. No. ______ (Attorney Docket No. 318037.01), U.S. patent application Ser. No. ______ (Attorney Docket No. 320253.01), U.S. patent application Ser. No. ______ (Attorney Docket No. 320255.01), and U.S. patent application Ser. No. ______ (Attorney Docket No. 320256.01), each of which is incorporated herein by reference in its entirety.

### BACKGROUND

Web-based social networking has become a popular way for people to meet and interact with people over public networks like the Internet. Typically, social networking is implemented by websites that provide a social networking service. Social networking services are often stand alone or dedicated web-based services although some services are integrated as part of other service offerings.

To use a web-based social networking service, a member may provide information to set up an account with a social networking service. Once members' accounts are configured, they can generate “profiles” of themselves. The profiles typically contain a variety of information about a user (such as location, occupation, hobbies, likes/dislikes, friends/social graph, etc.).

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Profiles that are character-based and which reflect various brand assets are supported in a social networking service by an arrangement that enables members to interact with the branded character-based profiles in the same way as profiles of any real members of the social network. Branded characters may thus be befriended and their profiles shared with other users, rated, and discussed. Notifications of activities of the branded characters can be received by a member such as when new content is posted to the character's profile, the release of a movie from which the character is drawn, or a promotion event or giveaway that involves the character. The brand assets associated with the character can be drawn from a variety of different brand sources including, for example, personalities, artists, celebrities, products, services, popular culture (e.g., movies, television, books, magazines, websites, blogs, etc.), institutions, etc., in both commercial and non-commercial contexts.

In various illustrative examples, the social networking service is supplemented by an on-line media content delivery service. The media content delivery service is adapted to enable media content to be selected, delivered, and rendered on the personal media player as well as a client PC that is connected to the service over the Internet. The profile pages for both real members and branded characters in the social network employ a construct of a “member card” which is automatically kept up to date to reflect the media content the members like (and in the case of real members, the media content that they play on their player or client PC). Member cards can be customized with the member's own pictures, background, and status updates, for example, as well as branded character-based profiles that the member may select and include in the member card. The member card assets, including branded characters (or a subset of the branded characters and associated brand assets), may reside on the PC player application and the personal media player, and can be transferred to other players using a wireless peer-to-peer communications protocol. Such member card assets may also be included in social networking and other types of websites that are hosted by third parties.

Advantageously, the present support of branded characters in a social networking service environment gives members even more ways to customize and personalize their on-line identities and enjoy new ways of discovering and interacting with media content. Many people strongly associate with brands particularly as there is often a significant cultural connection between consumption habits and lifestyle in many parts of the world. For these people, brands can be important parts of both their real and on-line personas and being able to interact with branded characters will help to enhance their social networking experiences.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative usage environment in which a user may listen to audio content and watch video content rendered by an illustrative personal media player;

FIG. 2 shows a front view of an illustrative personal media player that supports a graphical user interface (“GUI”) on a display screen, as well as user controls;

FIG. 3 shows the portable media player when docked in a docking station that is operatively coupled to a PC and where the PC is connected to a media content delivery and a social networking service over a network such as the Internet;

FIG. 4 shows an illustrative member card which is utilized as part of any member's profile page that is supported by a social networking service;

FIG. 5 shows an illustrative character-based member card with embedded brand assets;

FIG. 6 is a diagram that shows various illustrative interactions that may be implemented with a branded character;

FIG. 7 shows an illustrative web page supported by a social networking service in which a branded character is befriended by a member;

FIG. 8 shows an illustrative personal media player on which a subset of brand assets from a member card are installed, and which may be wirelessly transferred to another player using a wireless communications protocol in support of peer-to-peer networking;

FIG. 9 is a simplified block diagram that shows various functional components of an illustrative example of a personal media player; and

FIG. 10 is a simplified block diagram that shows various physical components of an illustrative example of a personal media player.

Like reference numerals indicate like elements in the drawings. Elements are not drawn to scale unless otherwise indicated.

### DETAILED DESCRIPTION

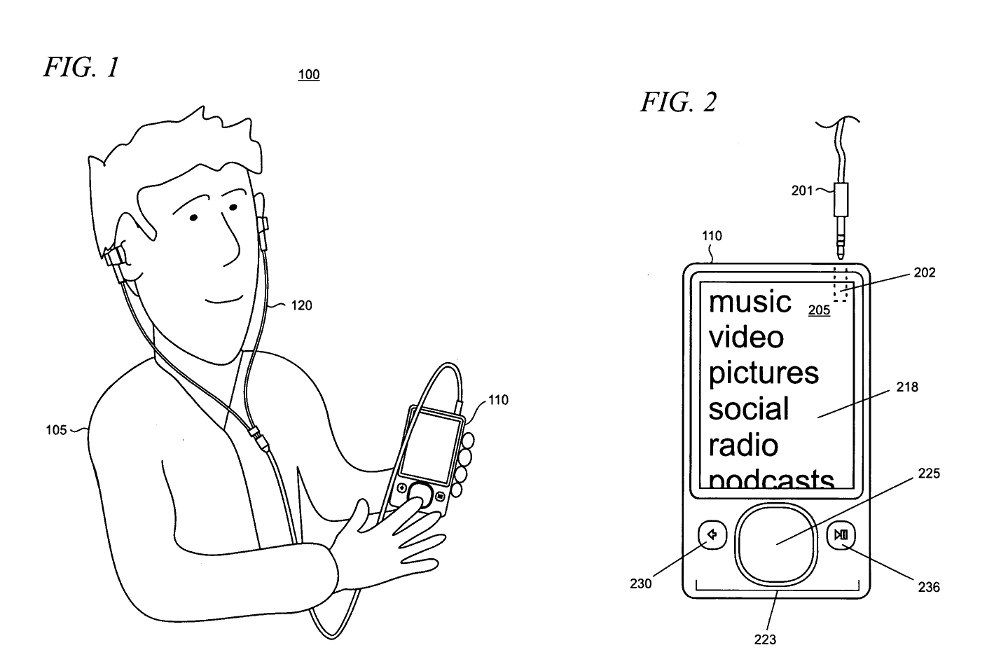

FIG. 1 shows an illustrative portable device usage environment 100 in which a user 105 interacts with digital media content rendered by a personal media player 110. In this example, the personal media player 110 is configured with capabilities to play audio content such as MP3 files or content from over-the-air radio stations, display video and photographs, and render other content. The user 105 will typically use earphones 120 to enable audio content, such as music or the audio portion of video content, to be consumed privately (i.e., without the audio content being heard by others) and at volume levels that are satisfactory for the user while maintaining good battery life in the personal media player. Earphones 120 are representative of a class of devices used to render audio content which may also be known as headphones, earbuds, headsets, and by other terms. Earphones 120 generally will be configured with a pair of audio speakers (one for each ear), or less commonly a single speaker, along with a means to place the speakers close to the user's ears. As shown in FIG. 2, the speakers are wired via cables to a plug 201. The plug 201 interfaces with an audio jack 202 in the personal media player 110.

FIG. 2 also shows a GUI 205 that is rendered on a display screen 218, and user controls 223 that are built in to the personal media player 110. The GUI 205 uses menus, icons, and the like to enable the user 105 to find, select, and control playback of media content that is available to the player 110. In addition to supporting the GUI 205, the display screen 218 is also used to render video content, typically by turning the player 110 to a landscape orientation so that the long axis of the display screen 218 is parallel to the ground.

The user controls 223, in this example, include a gesture pad 225, called a G-Pad, which combines the functionality of a conventional directional pad (i.e., a “D-pad”) with a touch sensitive surface as described in U.S. Patent Application Ser. No. 60/987,399, filed Nov. 12, 2007, entitled “User Interface with Physics Engine for Natural Gestural Control,” owned by the assignee of the present application and hereby incorporated by reference in its entirety having the same effect as if set forth in length. A “back” button 230 and a “play/pause” button 236 are also provided. However, other types of user controls may also be used depending on the requirements of a particular implementation.

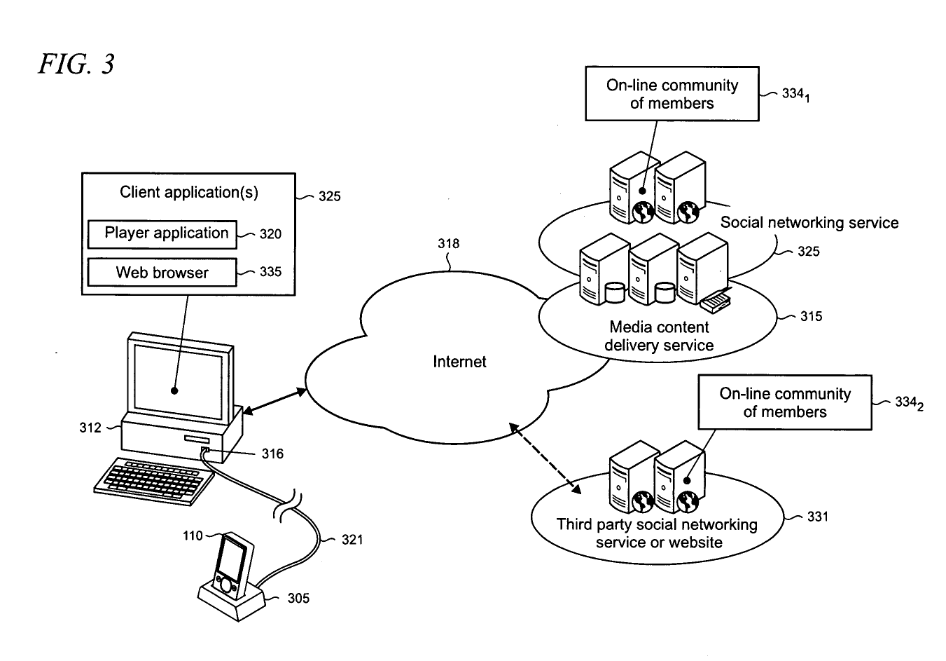

FIG. 3 shows the personal media player 110 as typically inserted into a dock 305 for synchronization with a PC 312. Dock 305 is coupled to an input port 316 such as a USB (Universal Serial Bus) port with a synchronization (“sync”) cable 321, in this example. Other arrangements may also be used to implement communications between the personal media player 110 and PC 312 including, for example, those employing wireless protocols such as Bluetooth, or Wi-Fi (i.e., the Institute of Electrical and Electronics Engineers, IEEE 802.11 standards family) that enable connection to a wireless network or access point. The wireless communications capability in the player 110 can also be utilized to implement peer-to-peer connectivity with other players that are similarly equipped.

The personal media player 110 is arranged to be operatively couplable with the PC 312 using a synchronization process by which data may be exchanged or shared between the devices. The synchronization process implemented between the PC 312 and personal media player 110 typically enables media content such as music, video, images, games, information, and other data to be downloaded from an on-line source or media content delivery service 315 over a network such as the Internet 318 to the PC 312. In this way, the PC 312 operates as an intermediary or proxy device between the service 315 and the personal media player 110.

The media content provided by the service 315 will typically be organized and presented to the user 105 using a player application 320 that runs on the PC 3 12. The player application 320 is arranged to enable the user 105 to browse, select, and download media content from the service 315, often on a fee basis or as part of a subscription plan. In some cases, advertising supported business models may also be utilized. The downloaded media content can be consumed on the PC 312 or be transferred to the personal media player 110. Media content may be protected in some instances where its limitations on its use may be enforced by various DRM (digital rights management) systems that interoperate between the PC 312 and the player 110.

In this example, a social networking service 325 supplements the media content delivery service 315. The social networking service 325 can be supported by a common service provider, as shown, but a service 331 may alternatively be provided by a third party (as indicated by the dashed line in FIG. 3). In each case, the social networking service will typically support an on-line community of members, as indicated by reference numerals 334₁ and 334₂.

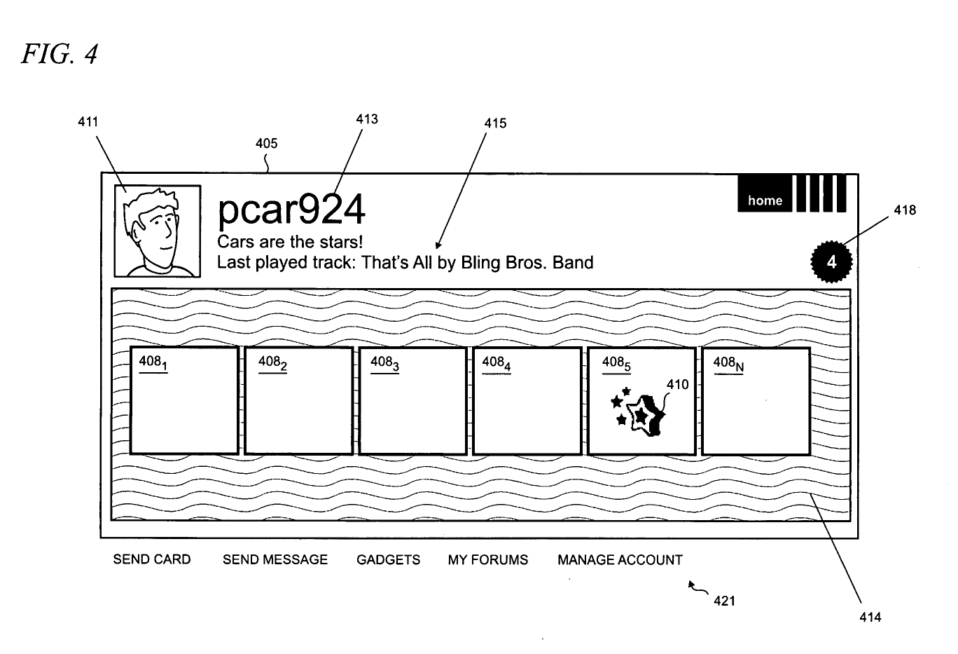

The user 105 will typically use a web browser 335 running on the PC 312 to interact with the social networking service 325. The social networking service 325 enables the online community of members 334 to explore, discover, and share media content experiences, typically including music and video. The members 334 each have a profile page featuring a member card 405 that is supported by the social networking service 325, as illustratively shown in FIG. 4.

The member card 405 is automatically updated by the service 325, in this example, to reflect the music that a member plays either on their personal media player (e.g., player 110) or on the player application (e.g., player application 320) that runs on a PC. These updates are reflected by a series of tiles 408_{1, 2 . . . N} that are arranged in a moveable filmstrip-like arrangement that may be configured to scroll horizontally across the member card 405, for example. The tiles 408 will typically show a graphical representation, or thumbnail, to represent the music and may include icons, photographs, text, etc. Typically, the tiles 408 are configured as active links to the music content that they represent.

In some cases, a tile 408 may be used as a badge or other token to indicate a particular status or reputation of a member 334 in the social network. For example a member 334 might receive a badge 410 for being a “power poster” (i.e., a member who posts beyond a certain number of posts on forums hosted by the service 325). The badges 410 can use different graphical symbols to denote different types of recognition.

A member 334 is able to pick a picture 411 to be included in the member card 405, as well as a nickname, username, or “tag” or similar type of identification 413. The member card 405 can also be customized with a member-supplied background image 414, or the member 334 can pick from an assortment of service-supplied backgrounds. The member card 405 is also arranged, in this example, to show current status information such as the last song played (as indicated by reference numeral 415) and the reputation of the member as reflected by a numerical reputation badge 418. An assortment of navigation controls, collectively identified by reference 421, is also provided as shown.

The social networking service 325 allows members of its service to create member cards, and then uses these cards as a method to allow members to interact with their friends, receive recommendations, and discover new music. Specifically, member can download cards which have music snippets or full lengths songs from a friend to his device and then play them. The member is able thereby to discover new music by simply interacting with his friends. The member cards can also have status information or message information from a friend to the member. They can act as a mini blog and provide daily updates on the friend's activities. The member can select to have a friend's card on his own web page, blog, or other site, and can keep up to date on his friend using the card. In the present arrangement, member cards are advantageously created by the service 325 for branded characters. This invention allows commercial entities to interact with members as a “friend”, by utilizing the infrastructure of the service 325 to communicate with the member. Branded characters are comprised of a brand asset, which, as that term is used herein, is typically any kind of symbol, text, graphic, brand iconography, or combination thereof that may be used to evoke an association with a brand source. Sources can include, for example, personalities, artists, celebrities, products, services, and institutions, in both commercial and non-commercial contexts. Common examples of brand sources would include content and service providers and manufacturers of products that are targeted to consumers. Other typical sources of brand content are those associated with popular culture including movie and television productions, radio, magazines, web sites, blogs (web logs), sports teams, and the like. It is emphasized, however, that these lists are intended to be illustrative and are not exhaustive.

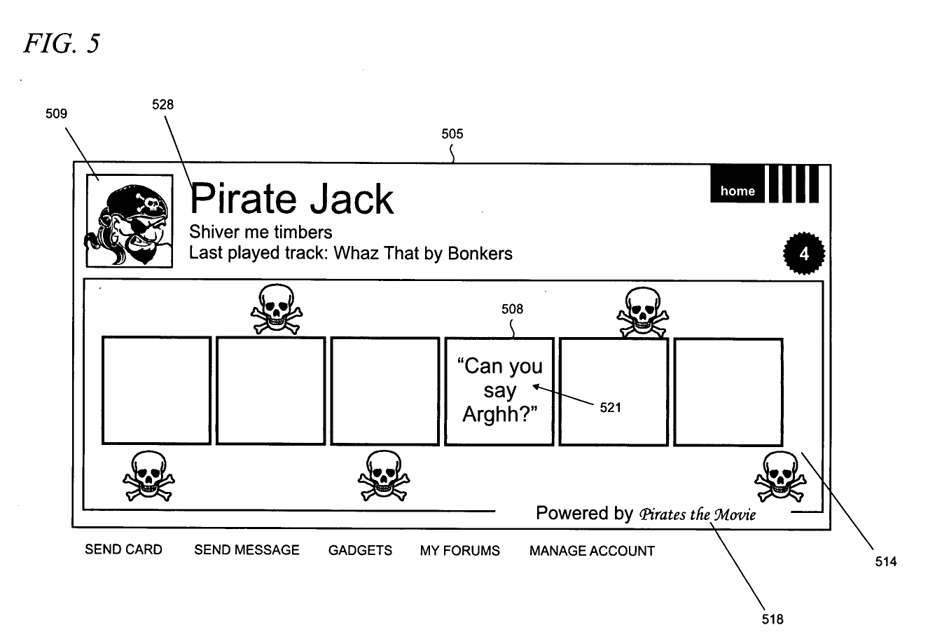

FIG. 5 shows an illustrative character-based profile for a movie character named “Jack the Pirate” that is implemented using a member card 505 that includes embedded brand assets. The embedded brand assets include a picture of the character 509 and a branded background 514 for the member card 505 that is associated with a particular brand source which, in this example, is a fictitious movie production called “Pirates the Movie”. The branded background 514 includes graphics that are associated with pirate theme and identifies the movie by its logo 518. One of the tiles 508 includes the movie's slogan 521 and the movie's iconic exclamation point 625 is located next to the member's identification tag 528.

The collection of the particular icons, slogans, logos, badges, and branded backgrounds, etc., used as brand assets for any given member card can differ from what is illustratively shown in FIG. 5 depending on the needs of a particular implementation scenario.

In addition, to branded assets, the branded character will also have a personality or characteristic reflective of the character. For example, the characteristics of the branded character can range from the ordinary to the fantastic and include everything in between. The likes and dislikes of the character may closely match the character's personality as portrayed in various media outlets. In the case of the movie character “Jack the Pirate”, his profile shows he likes music to “plunder by” he has a pet parrot, but hates stormy weather, and swimming.

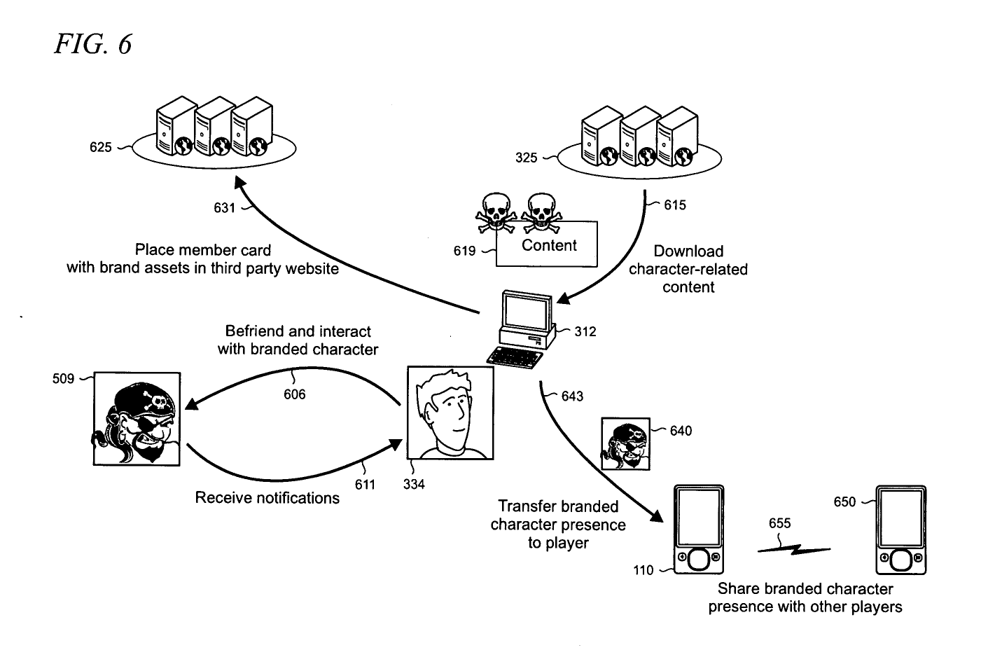

FIG. 6 is a diagram that shows various illustrative interactions that may be implemented with a branded character 509. Generally, the branded character 509 and its associated brand assets will generally be usable by members 334 just like any other asset or object that may be profiled in a member card. Thus, members can apply actions to the branded assets so that they can be discussed by other members, rated, and shared, for example.

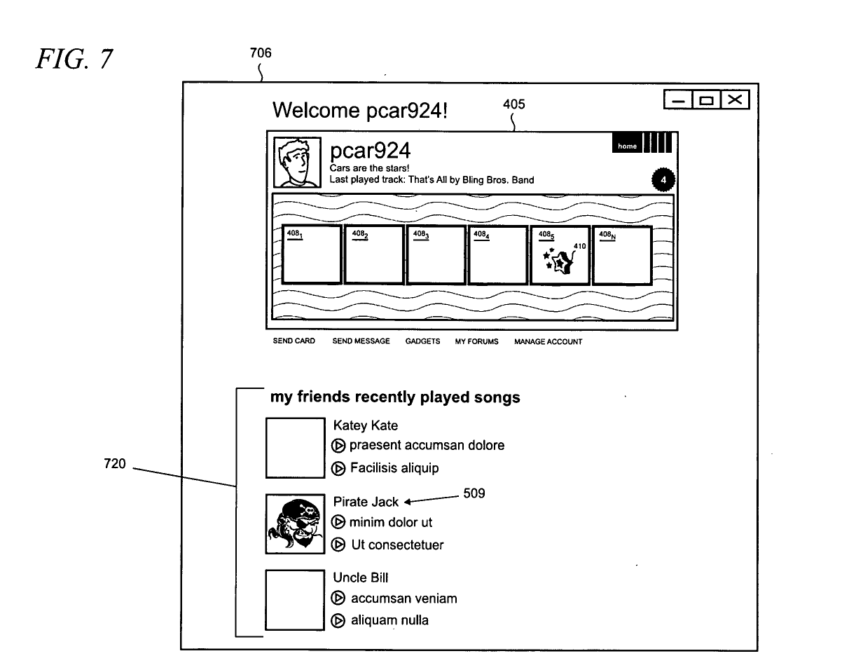

More specifically, as indicated by arrow 606 in FIG. 6, the service 325 enables a member 334 to befriend and interact with the branded character 509 as if the branded character were a real member. This is illustratively shown in FIG. 7 where a web page 706 supported by the service 325 includes the branded character 509 as a friend of the member 443. Below the member card 405 of the member 443, is a listing of songs 720 that were recently played by the friends of the member 443. Included within the listing 720 is a listing for the branded character 509 with which the member can interact just like a listing associated with other real members of the social network. For example, someone visiting the member's page 706 can browse through the songs and listen to portions (or in some cases, all) of the songs listed as being recently played by the branded character 509. This allows the commercial entity creating the branded character 509 to promote music relevant to the commercial entity, such as songs from a soundtrack of a movie in which the character appears. Alternatively, the commercial entity can promote any music it believes is keeping in taste of the character 509, to preserve the character's credibility to the audience. By creating branded characters 509 that are deployed on a service 325 and can take advantage of the social network service's infrastructure, the commercial entity creating the character 509 and the service 325 can benefit by having members gravitate toward the service 325 to befriend the character 509.

Returning back to FIG. 6, the member 334 can also receive notifications, for example, using a messaging system or other data feed that is implemented by the service 325 as shown by arrow 611. These notifications can provide various types of information to the member 334 including activities and events that are associated with the branded character 509. For example, a notification can be generated when new music is added to the branded character's member card 505, or if a sequel to the movie is released, a promotion or other event involving the branded character 509 is being held, and so on.

In some implementations, the service 325 will enable a member 443 to embed the brand character's member card or associated brand assets into web sites 625 hosted by third parties, as indicated by arrow 631. Such web sites could comprise other social networking sites or services, for example, that are affiliated with the service 325, or otherwise agree to accept branded content from outside sources.

The member 334 is further enabled by the service 325 to browse, select, and download media content 619 from the service 325 (or alternatively an affiliated service, or third party service) to the PC 312 that is specifically associated with the branded character 509, as indicated by arrow 615. This could include, for example, a movie trailer, related game content, music, movie theme music, critical reviews, and the like.

A subset of brand assets which are sufficient to provide a branded character presence 640 on the player 110 may also be transferred from the PC 312 to the player as indicated by arrow 643. Once the branded character presence is on the player 110, it may be transferred wirelessly to other player 650, as indicated by arrow 655.

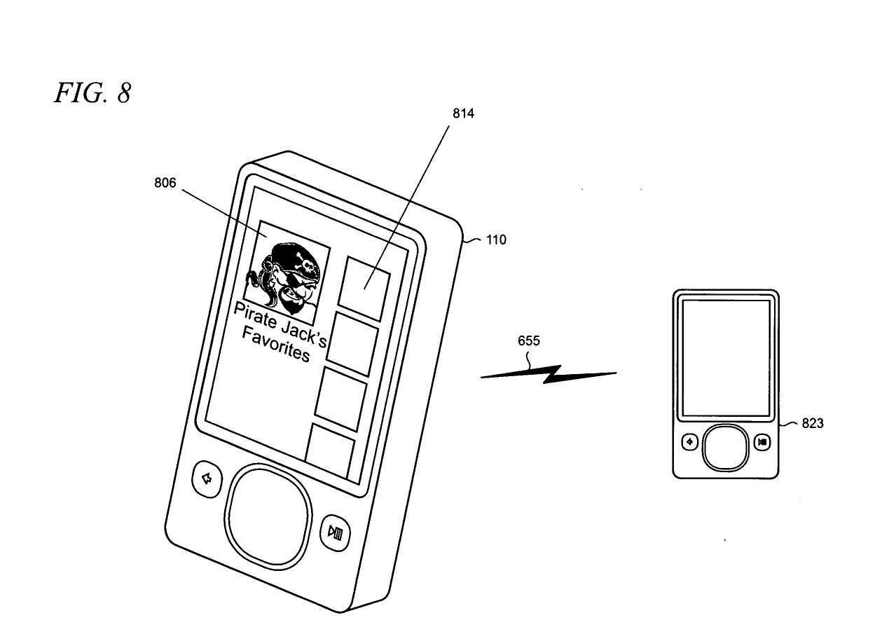

As shown in more detail in FIG. 8, the media player 110 has a subset of brand assets associated with the branded character installed. As shown, an image 806 of the branded character is shown along with one or more tiles 814 that indicate, for example, favorite songs of the branded character. In alternative arrangements the entire branded character member card 505 and all its brand assets may be transferred to the player 110. Transfer of branded character presence and/or brand assets from the PC 312 to the player 110 may be performed during data synchronization, for example. Once on the player 110, branded character presence and/or member cards and brand assets such as branded backgrounds and tiles may then be wirelessly transferred to another player 650 using a wireless communication protocol in support of peer-to-peer networking as indicated by arrow 655.

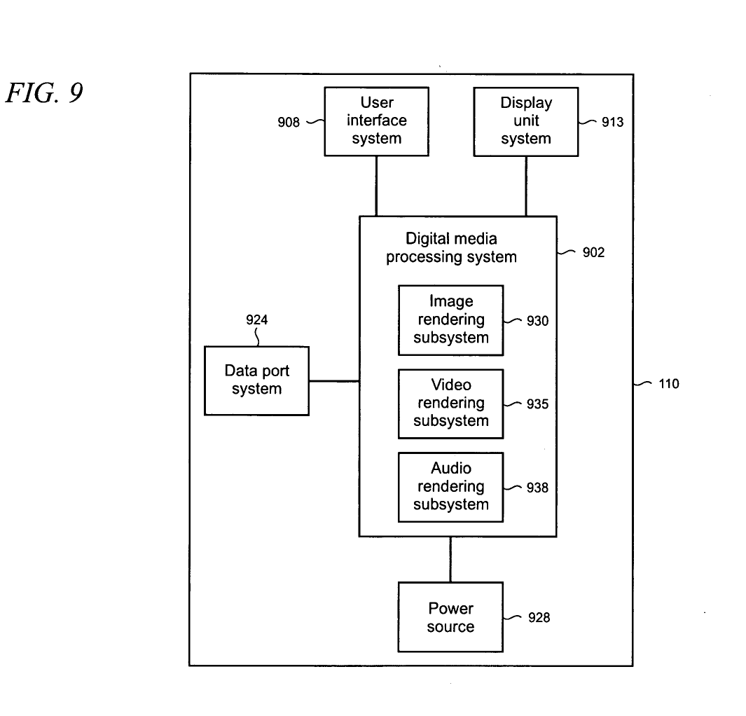

FIG. 9 a simplified block diagram that shows various illustrative functional components of the personal media player 110. The functional components include a digital media processing system 902, a user interface system 908, a display unit system 913, a data port system 924, and a power source system 928. The digital media processing system 902 further comprises an image rendering subsystem 930, a video rendering subsystem 935, and an audio rendering subsystem 938.

The digital media processing system 902 is the central processing system for the personal media player 110 and provides functionality that is similar to that provided by the processing systems found in a variety of electronic devices such as PCs, mobile phones, PDAs, handheld game devices, digital recording and playback systems, and the like.

Some of the primary functions of the digital media processing system 902 may include receiving media content files downloaded to the player 110, coordinating storage of such media content files, recalling specific media content files on demand, and rendering the media content files into audio/visual output on the display for the user 105. Additional features of the digital media processing system 902 may also include searching external resources for media content files, coordinating DRM (digital rights management) protocols for protected media content, and interfacing directly with other recording and playback systems.

As noted above the digital media processing system 902 further comprises three subsystems: the video rendering subsystem 935 which handles all functionality related to video-based media content files, which may include files in MPEG ( Moving Picture Experts Group) and other formats; the audio rendering subsystem 938 which handles all functionality related to audio-based media content including, for example music in the commonly-utilized MP3 format and other formats; and the image rendering subsystem 930 which handles all functionality related to picture-based media content, including for example JPEG (Joint Photographic Experts Group), GIF (Graphic Interchange Format), and other formats. While each subsystem is shown as being logically separated, each may in fact share hardware and software components with each other and with the rest of the personal media player 110, as may be necessary to meet the requirements of a particular implementation.

Functionally coupled to the digital media processing system 902 is the user interface system 908 through which the user 105 may exercise control over the operation of the personal media player 110. A display unit system 913 is also functionally coupled to the digital media processing system 902 and may comprise the display screen 222 (FIG. 2). Audio output through the audio jack 430 (FIG. 4) for playback of rendered media content may also be supported by display unit system 913. The display unit system 913 may also functionally support and complement the operation of the user interface system 908 by providing visual and/or audio output to the user 105 during operation of the player 110.

The data port system 924 is also functionally coupled to the digital media processing system 902 and provides a mechanism by which the personal media player 110 can interface with external systems in order to download media content. The data port system 924 may comprise, for example, a data synchronization connector port, a network connection (which may be wired or wireless), or other means of connectivity.

The personal media player 110 has a power source system 928 that provides power to the entire device. The power source system 928 in this example is coupled directly to the digital media processing system 902 and indirectly to the other systems and subsystems throughout the player. The power source system 928 may also be directly coupled to any other system or subsystem of the personal media player 110. Typically, the power source may comprise a battery, a power converter/transformer, or any other conventional type of electricity-providing power source, personal or otherwise.

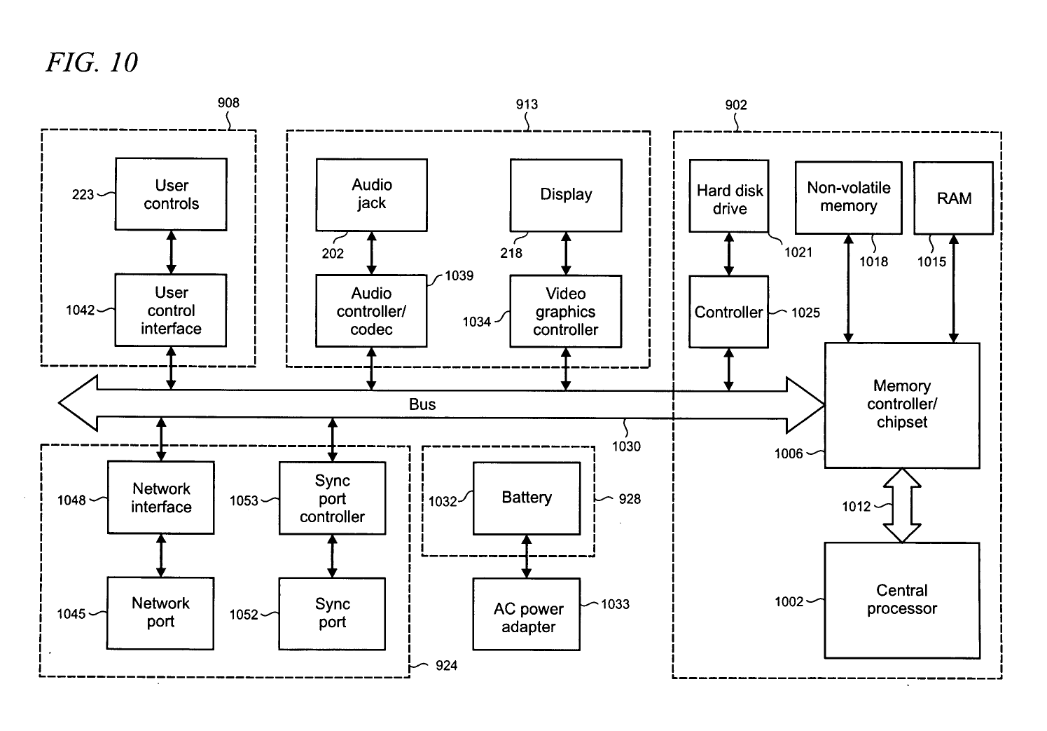

FIG. 10 is a simplified block diagram that shows various illustrative physical components of the personal media player 110 based on the functional components shown in FIG. 9 and described in the accompanying text (which are represented in FIG. 10 by dashed lines) including the digital media processing system 902, the user interface system 908, the display unit system 913, the data port system 924, and the power source system 928. While each physical component is shown as included in only a single functional component in FIG. 10 the physical components may, in fact, be shared by more than one functional component.

The physical components include a central processor 1002 coupled to a memory controller/chipset 1006 through, for example, a multi-pin connection 1012. The memory controller/chipset 1006 may be, in turn, coupled to random access memory (“RAM”) 1015 and/or non-volatile memory 1018 such as solid-state or Flash memory. These physical components, through connectivity with the memory controller/chipset 1006, may be collectively coupled to a hard disk drive 1021 (or other solid-state memory) via a controller 1025, as well as to the rest of the functional component systems via a system bus 1030.

In the power supply system 928, a rechargeable battery 1032 may be used to provide power to the components using one or more connections (not shown). The battery 1032, in turn, may also be coupled to the external AC power adapter 305 (FIG. 3) or receive power via the sync cable 212 when it is coupled to the PC 220 (FIG. 2).

The display screen 222 is associated with a video graphics controller 1034. The video graphics controller will typically use a mix of software, firmware, and/or hardware, as is known in the art, to implement the GUI on the display screen 222. Along with the audio jack 430 and its associated audio controller/codec 1039, these components comprise the display unit system 913 and may be directly or indirectly connected to the other physical components via the system bus 1030.

The user controls 225 are associated with a user control interface 1042 in the user interface system 908 that implements the user control functionality that is used to support the interaction with the GUI as described above. A network port 1045 and associated network interface 1048, along with the sync port 1053 and its associated controller 1052 may constitute the physical components of the data port system 924. These components may also directly or indirectly connect to the other components via the system bus 1030.

It will be appreciated that the principles of the present slide and click combination switch may be generally applied to other devices beyond media players. Such devices include, for example, mobile phones, PDAs, smart phones, handheld game devices, ultra-mobile computers, devices including various combinations of the functionalities provided therein, and the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for enabling interaction with a branded character in a user profile page supported by a social networking service, the method comprising the steps:
providing a portal from which a user may browse and select from an assortment one or more brand assets for inclusion in the profile page, the brand assets being usable to evoke a connection with a brand source;
embedding a selected brand asset in the profile page;
enabling the user to manipulate the brand assets on the profile page including at least one of sharing the brand assets, receiving ratings on the brand assets from social network members, and discussing the brand assets.

2. The method of claim 1 in which the profile page includes a member card that is arranged to be updated by the service to reflect consumption of media content by the user.

3. The method of claim 2 in which the member card is further arranged to include tiles representing ones of links to the consumed media content or badges that are indicative of reputation.

4. The method of claim 1 including the further steps of receiving uploads of personalized content from the user and embedding the personalized content in the profile page, the personalized content comprising at least one of pictures, backgrounds, or updates.

5. The method of claim 1 in which the brand sources comprise one of service provider or product manufacturer.

6. A computer-readable medium containing instructions which, when executed by one or more processors disposed in an electronic device, implement a platform supporting use of brand assets on a user profile page attendant to a social network, the platform performing a method comprising the steps of:
showing on a GUI an assortment from which a member of the social network may select one or more brand assets to be associated with the member;
enabling selection of brand assets by the user; and
transferring the selected brand assets to a personal media player

7. The computer-readable medium of claim 6 in which the brand assets are associated with one of personalities, artists, celebrities, products, services, or institutions.

8. A personal media player, comprising:
a digital media processing system and a display screen, the digital media processing system interfacing with the display screen to render digital media content in the form of images or video;
memory bearing computer-readable instructions which, when executed by one or more processors in the personal media player, support a GUI that is rendered on the display screen, the GUI being arranged to show brand assets received from a remote host device; and
memory bearing computer-readable instructions which, when executed by one or more processors in the personal media player, enable transfer of selected brand assets to a remote personal media player.

9. The personal media player of claim 8 in which the transfer is implemented using a wireless peer-to-peer networking protocol.

10. The personal media player of claim 9 in which networking protocol conforms to IEEE 802.11.

11. The personal media player of claim 8 in which the brand assets are implemented using one of logo, slogan, graphic, iconography, background, photograph, text, or a combination thereof.
